(19) United States
(12) Patent Application Publication
(10) Pub. No.: US 2024/0413563 A1
(43) Pub. Date: Dec. 12, 2024

(54) OBD II Port Lock

(71) Applicant: Peter Wiedemann, Acworth, GA (US)

(72) Inventor: Peter Wiedemann, Acworth, GA (US)

(21) Appl. No.: 18/612,876

(22) Filed: Mar. 21, 2024

Related U.S. Application Data
(60) Provisional application No. 63/506,772, filed on Jun. 7, 2023.

(51) Int. Cl. H01R 13/44; B60R 16/023; G07C 5/00

(52) U.S. Cl. CPC H01R 13/44; B60R 16/0231; G07C 5/008; G07C 2205/02

(57) ABSTRACT

An on-board diagnostics (OBD) port lock for providing protection against unauthorized access to a vehicle OBD port. The port lock includes an arm member, a base member, and a fastener. The ODB port is inserted into the base member. The arm member the connects to the base member, while latching onto the OBD port. The fasteners, having a user distinct screw slot, then secured the arm member, base member, and OBD port together. A user distinct screw slot prevents unauthorized users from simply removing the screws without possessing the proper key.

### FIELD OF THE INVENTION

The present invention relates generally to a security means for a motor vehicle. More specifically, the present invention is a port lock for an on-board diagnostic port.

### BACKGROUND OF THE INVENTION

The OBD 2 (On-Board Diagnostics) port is an essential component found in modern vehicles, providing a standardized interface for accessing and retrieving diagnostic information from the vehicle's onboard computer system. It has become a crucial tool for automotive technicians, mechanics, and vehicle owners alike. The OBD 2 port allows for the connection of external devices, such as diagnostic scanners or monitoring systems, in order to communicate with the vehicle's internal computer system. Automotive technicians and mechanics rely on the OBD 2 port to perform a wide range of diagnostic functions. By connecting a compatible diagnostic scanner or tool to the port, they can access valuable information about the vehicle's performance, identify any malfunctions or error codes, and perform necessary repairs or maintenance. This enables efficient troubleshooting, reduces labor time, and promotes accurate diagnoses. The OBD 2 port, typically located beneath the dashboard or steering column of a vehicle, consists of a 16-pin connector that enables communication between the vehicle's internal computer system and an external device. This standardized port has been mandated by regulations in many countries, including the United States, to ensure compatibility and facilitate efficient diagnostics.

Despite the numerous advantages offered by the OBD 2 port, its accessibility can present security risks. As the port is easily accessible and lacks built-in security measures, it can be vulnerable to unauthorized access and potential misuse. With the increasing reliance on electronic systems within vehicles, the need for protecting the OBD 2 port against unauthorized connections has become paramount. Unauthorized access to the OBD 2 port can potentially lead to various security concerns. For instance, malicious individuals could gain access to the vehicle's internal computer system, potentially manipulating crucial settings or stealing sensitive data. Furthermore, unauthorized connection of devices to the OBD 2 port may result in software corruption, compromising the vehicle's functionality and safety. Therefore, there is a need for an effective solution to secure the OBD 2 port while maintaining its accessibility for legitimate diagnostic purposes.

An objective of the present invention is to provide an ODB 2 Port Lock that effectively prevents unauthorized access to the ODB 2 port of a vehicle. The ODB 2 Port Lock, in the present invention, is designed with a casing and face plate that securely slides onto the ODB 2 port, creating a physical barrier that restricts direct access to the port. The casing is constructed to fit snugly and provide a tight seal, preventing unauthorized individuals from tampering with or connecting devices to the ODB 2 port without authorization, while the face plate coupled to the casing. An additional objective of the present invention is to ensure the accessibility of the ODB 2 port for authorized diagnostic purposes while maintaining its security against those unauthorized users. The ODB 2 Port Lock is prevents unauthorized access, while allowing for legitimate diagnostic connections when needed. By incorporating a face plate that covers the male connector of the ODB 2 port, the lock ensures that only authorized individuals with the appropriate tools can establish a secure connection to the vehicle's internal computer system. The ODB 2 Port Lock achieves a secure connection between the casing and the face plate through the use of threaded holes and specialized screws. The casing features threaded holes strategically positioned to align with corresponding holes on the face plate. The face plate incorporates holes that correspond to the threaded holes on the casing. By inserting the specialized screws through these aligned holes and tightening them, the face plate becomes firmly attached to the casing. This connection ensures that the lock remains intact and cannot be tampered with or removed without the use of the specialty key. Furthermore, an additional objective of the present invention is to incorporate specialized screws with a unique snake eye pattern, which can only be turned using a designated key, thereby deterring unauthorized individuals from attempting to bypass the lock. To enhance the security of the ODB 2 Port Lock, specialized screws with a unique snake eye pattern are utilized. These screws can only be turned using the designated specialty key that matches the pattern on the screw heads. This design feature prevents unauthorized individuals from using standard screwdrivers or tools to tamper with or remove the screws, thereby effectively deterring any attempts to bypass the lock. Lastly, the present invention provides a user-friendly design that allows for easy installation and removal of the ODB 2 Port Lock when legitimate access to the port is required. The ODB 2 Port Lock is designed with ease of use in mind. It incorporates a user-friendly design that allows for straightforward installation and removal of the lock when legitimate access to the ODB 2 port is required. The casing slides onto the port easily, and the face plate securely attaches to the casing using the specialized screws. When authorized diagnostic connections are necessary, the lock can be efficiently removed by using the designated specialty key to loosen and remove the screws, allowing access to the ODB 2 port.

By accomplishing these objectives, the ODB 2 Port Lock provides an effective and practical solution to address the security concerns associated with the ODB 2 port. It ensures that only authorized individuals with the specialty key can access and utilize the diagnostic capabilities of the ODB 2 port, protecting the integrity and safety of the vehicle's internal computer system.

### SUMMARY OF THE INVENTION

The present invention discloses an ODB 2 Port Lock comprising three primary components: a casing, a face plate, and two specialized screws. These components work in harmony to secure the ODB 2 port, preventing unauthorized access and ensuring the port remains accessible for legitimate diagnostic purposes. The ODB 2 Port Lock includes a casing designed to fit over the ODB 2 port. The casing features a recess that securely slides onto the port, providing a snug fit. To further enhance stability, the casing incorporates two threaded holes, strategically positioned to align with corresponding holes on the face plate. These holes accept attachment screws, allowing for a firm connection between the casing and the face plate. Additionally, the casing includes a cutout to accommodate an essential element of the face plate, promoting a secure and interlocking relationship between the two components.

The face plate is an integral part of the ODB 2 Port Lock, serving as the protective barrier for the connection port of the ODB 2 port. It connects to the casing, covering the port to prevent unauthorized access. The face plate is designed to align with the casing's cutout, providing a secure interlocking mechanism. To ensure a robust connection, the face plate incorporates two holes that correspond with the threaded holes on the casing. These holes align with the casing's holes and enable the attachment screws to pass through, securing the face plate tightly to the casing.

The ODB 2 Port Lock utilizes two specialized screws as a key component of its security mechanism. These screws serve the dual purpose of fastening the face plate to the casing while also acting as a deterrent to unauthorized access. The screws feature a unique snake eye pattern on their heads, which can only be turned using a specialty key specifically designed for this purpose. This snake eye pattern adds an extra layer of security by preventing the use of standard screwdrivers or tools to tamper with or remove the screws.

The three components of the ODB 2 Port Lock work together seamlessly to provide a comprehensive and effective solution for securing the ODB 2 port. The casing, with its recess and threaded holes, securely holds the face plate in place. The face plate, with its arm fitting snugly within the cutout of the casing, provides an interlocking connection that enhances stability. The holes on the face plate align with the threaded holes on the casing, allowing the specialized screws to be inserted and tightened, firmly securing the face plate to the casing. The snake eye pattern on the screw heads ensures that only the specialty key can be used to turn them, further enhancing the overall security of the lock.

### BRIEF DESCRIPTION OF THE DRAWINGS

FIG. 1 is a perspective exploded view of the present invention.

FIG. 2 is a rear perspective view of the arm member of the present invention.

FIG. 3 is a front perspective view of the arm member of the present invention.

FIG. 4 is a rear perspective view of the base member of the present invention.

FIG. 5 is a front perspective view of the base member of the present invention.

FIG. 6 is a is a front view of the fasteners of the present invention.

FIG. 7 is a top perspective view of the fasteners of the present invention.

FIG. 8 is a front exploded perspective view of the arm and base members of the present invention.

FIG. 9 is a rear exploded perspective view of the arm and base members of the present invention.

FIG. 10 is a rear view of the present invention, showing the method of coupling the arm member to the base member.

FIG. 11 is a front perspective of the arm member coupled to the base member.

FIG. 12 is a front perspective of the arm member coupled to the base member.

FIG. 13 is a front perspective of the present invention in the locked configuration.

FIG. 14 is a rear perspective of the present invention in the locked configuration.

FIG. 15 is a front perspective view of the present invention in the locked configuration secured to an OBD port.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification, and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate.

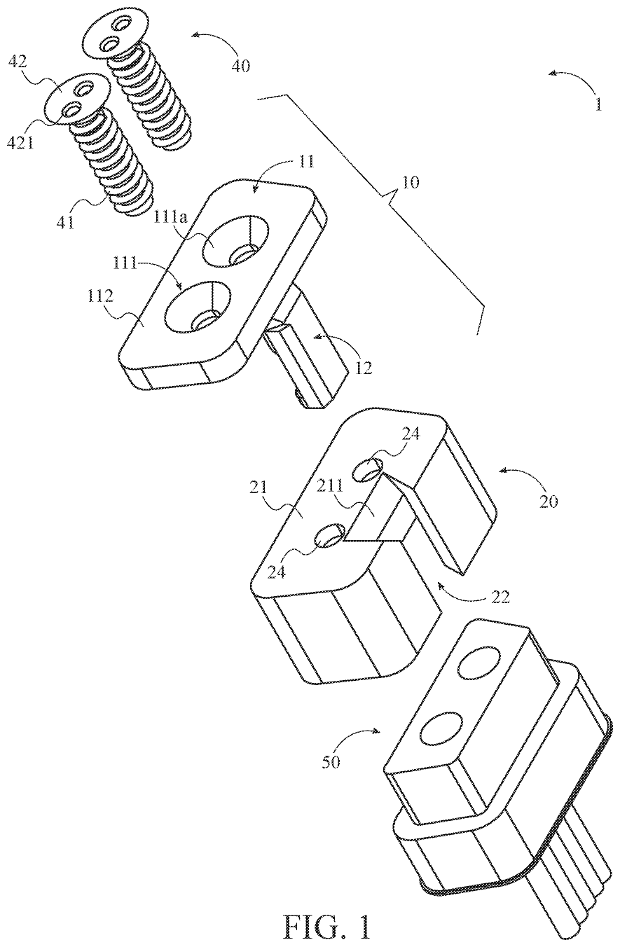

The present disclosure includes many aspects and features. Moreover, while many aspects and features relate to, and are described in the context of an on-board diagnostics port lock, embodiments of the present disclosure are not limited to use only in this context. As shown and described herein, FIGS. 1-15 are depictions and representations of some embodiments of the present invention and are not limited to such.

As shown in FIG. 1, the present invention is an on-board diagnostic port lock 1 comprising an arm portion 10, a base portion 20, and an at least one fastener 40. In the preferred embodiment of the present invention, the at least one fastener 40 is a plurality of fasteners. As shown in FIG. 1, the arm member 10 is adjacent to the base member 20, wherein the base member 20 receives an on-board diagnostics (ODB) port 50. The at least one fastener 40, couples the arm member 10 to the base member 20, thus securing the present invention onto the OBD port 50.

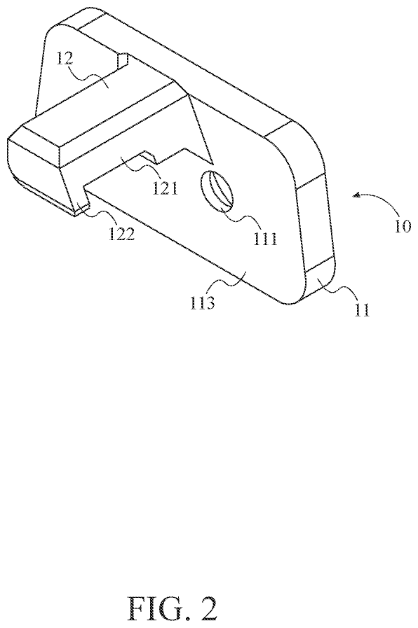

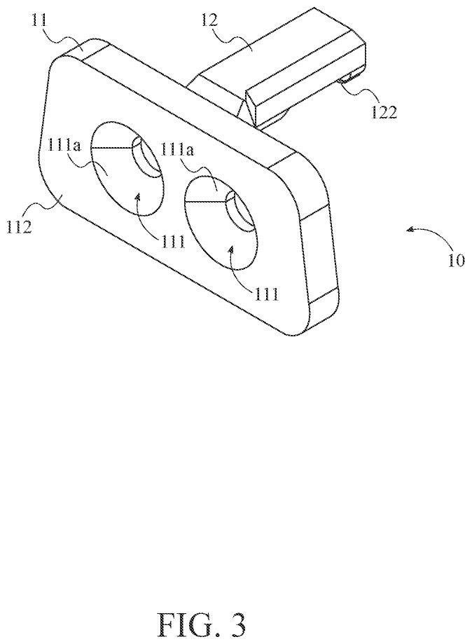

As shown in FIG. 2 and FIG. 3, the arm member 10 comprises a faceplate 11 and a protrusion 12. The faceplate 11 further comprises an at least one through hole 111, a front face 112, and a rear face 113. In the context of the present invention, the front face 112 is the outwardly forward-facing surface of the faceplate 11 whereby the rear face 113 is the surface of the faceplate 11, opposite of the front face 112. As further shown in FIG. 2, the protrusion 12 extends normally outward from the rear face 113 of the faceplate 11. Additionally, as seen, the protrusion 12 comprises an angled surface 121 and a ridge 122. In the preferred embodiment of the present invention, the angled surface 121 is a chamfered surface resembling an inverted taper, wherein said angle is 45° and by which the topmost portion of the protrusion 12 is narrower than the bottom most portion of the protrusion 12. In the context of the present invention, the ridge 122 is a member that extends downwardly from the protrusion 12 at a distal end. In the preferred embodiment of the present invention, the ridge 12 latches onto the OBD port 50 to prevent horizontal movement that may cause the present invention to disengage with the OBD port 50.

Furthermore, as shown in FIG. 2 and FIG. 3, the at least one through hole 111 traverses the faceplate 11. In the preferred embodiment of the present invention, the at least one through hole 111 is a plurality of through holes traversing the faceplate 11. As shown in FIG. 3, in the preferred embodiment of the present invention, the through holes 111 comprise a chamfer 111a, thereby providing a sunken hole in the front face 112 of the faceplate 111. In the preferred embodiment of the present invention, the chamfer 111a allows the fasteners 40 to be seated within the through, thereby sitting flush with the front face 112 of the faceplate 11.

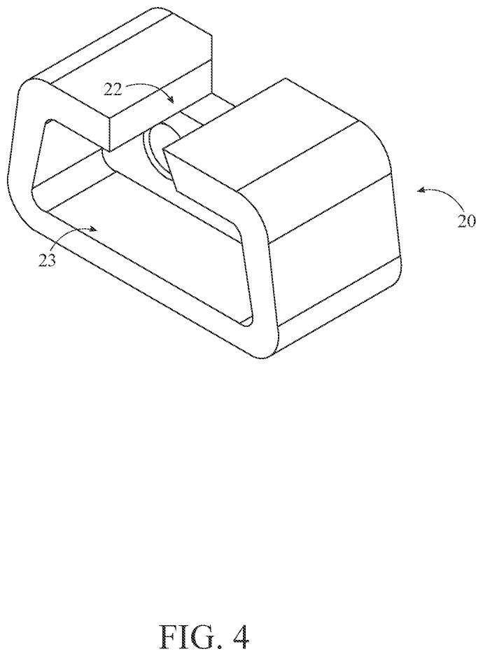

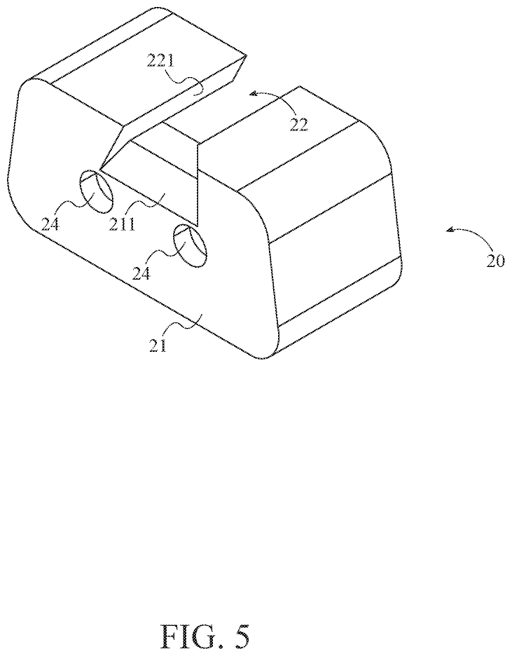

As shown in FIG. 4 and FIG. 5, the base member 20 of the present invention comprises a front facing surface 21, a channel 22, and a receiver cavity 23. In the context of the present invention, the front facing 21 surface is the forward-facing outward surface of the base member 20. The receiver cavity 23 is an extrusion located on the rear side of the base member 20. In the preferred embodiment of the present invention, the base member 20 further comprises an at least one threaded hole 24, as shown in FIG. 5, wherein said threaded hole 24 traverses the base member 20 from the front facing surface 21 to the receiver cavity 23. In some embodiments of the present invention, the at least one threaded hole 24 is provided using a threaded nut comprising threads that has been embedded into the base member 20. In such embodiments, the nut may be secured by melting the base member 20, and embedding the nut in the front facing surface 21, thus securing the nut in place. In the context of the present invention, the channel 22 is a cut out traversing the topmost portion of the base member 20. In the preferred embodiment, the channel 22 comprises an angled wall 221 having an inverted taper, wherein the angled wall 221 of the base member 20, corresponds to the angle of the angled surface 121 of the protrusion 12 of the arm member 10.

Additionally, in some embodiments of the present invention, as shown in FIG. 5, the front facing surface 21 of the base member 20 may further comprise a cutout 211. In such embodiments, the cutout 211 is design to allow the arm member 10 to sit flush against the front facing surface 21 of the base member 20.

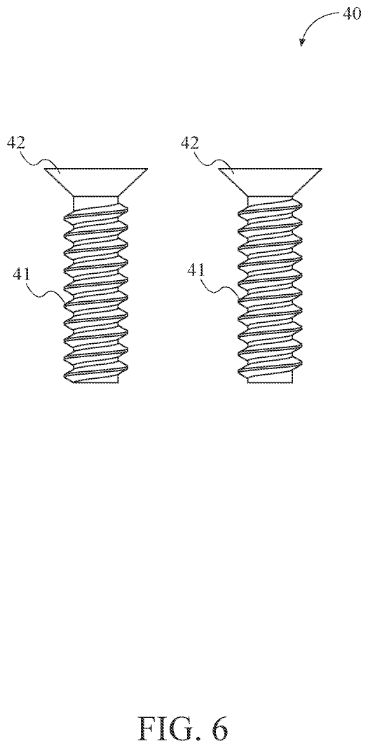

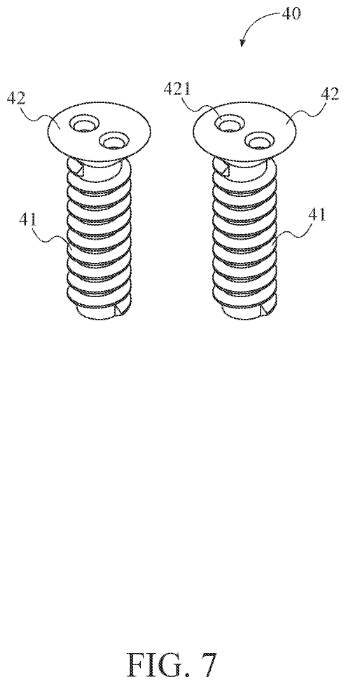

Referring to FIG. 6 and FIG. 7, the fasteners 40 of the present invention comprise a head 42 and a plurality of threads 41. In the context of the present invention, the fastener comprises the head 42, located at a distal end of the fastener 40 and the plurality of threads 41 compose a portion of a shaft of the fastener 40. In the preferred embodiments of the present invention, the head 42 of the fastener 40 comprises a screw slot 421. In such embodiments, the screw slot 421 is an uncommon pattern, such as a snake eye pattern, a star pattern, and similar patterns that are non-flathead and non-Phillip's head screw slot patterns. In the preferred embodiment of the present invention, a user must possess a key that shares the shape of the screw slot 421 to turn the fasteners 40. In the preferred embodiments, a universally common screw slot would be unideal as this would allow anybody to unlock the device, thus rendering the present invention obsolete. Therefore, it is crucial for the present invention to utilize fasteners 40 that comprise a snake eye pattern, such as that shown in FIG. 7, and other user distinct screw slot 421 patterns.

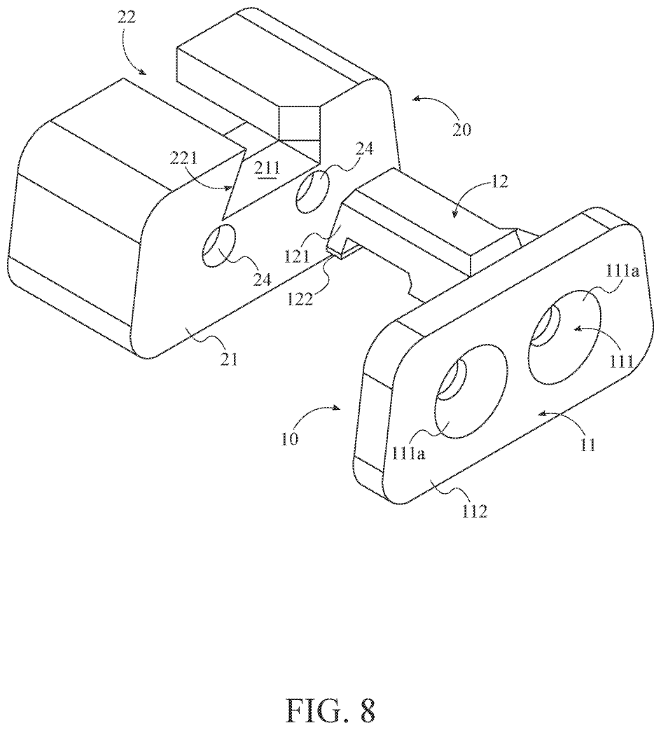

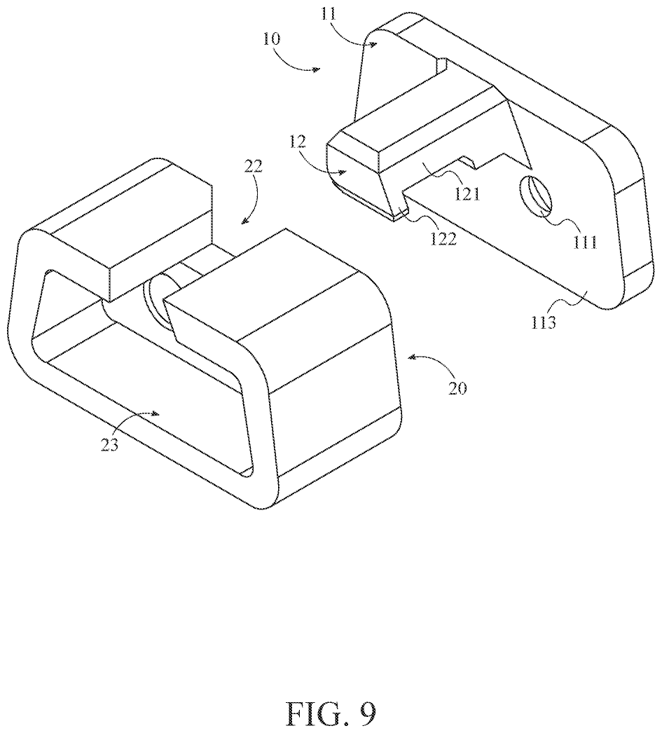

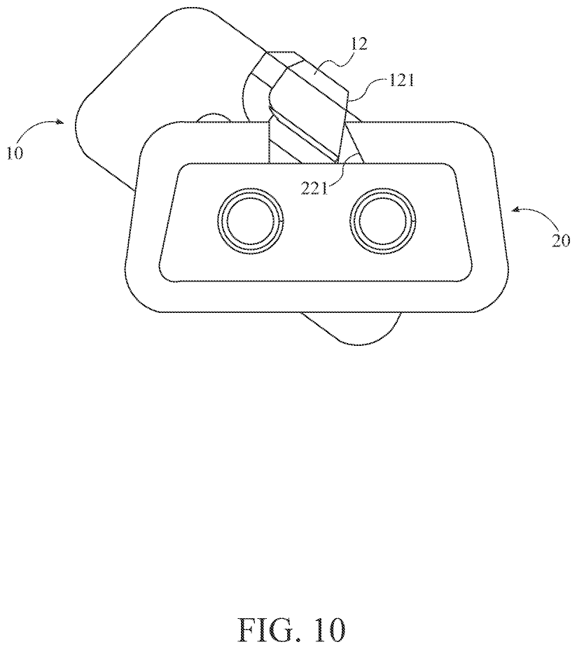

As shown in FIG. 8 and FIG. 9, in the preferred embodiment of the present invention, the present invention comprises an unlocked position, wherein the arm member 10 is disengaged from the base member 20. In the preferred embodiment, to use the present invention, the user must align the protrusion 12 to the channel 22, and rotate the arm member 10, as shown in FIG. 10, thereby allowing the angled surface 121 of the arm member 10 to avoid interference with the angled wall 221 of the base member 20.

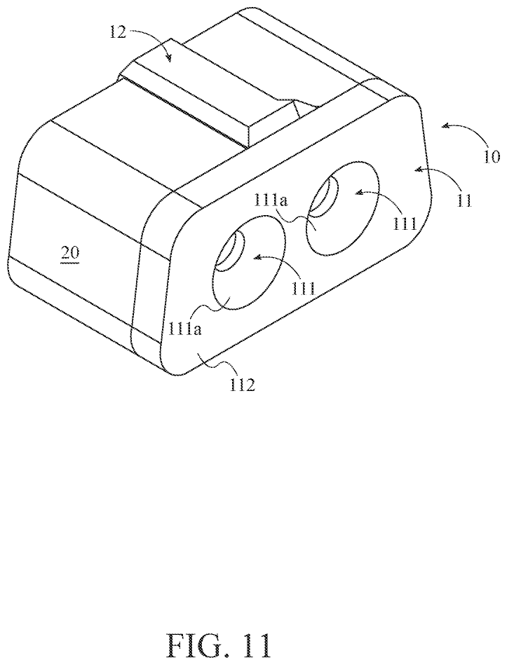

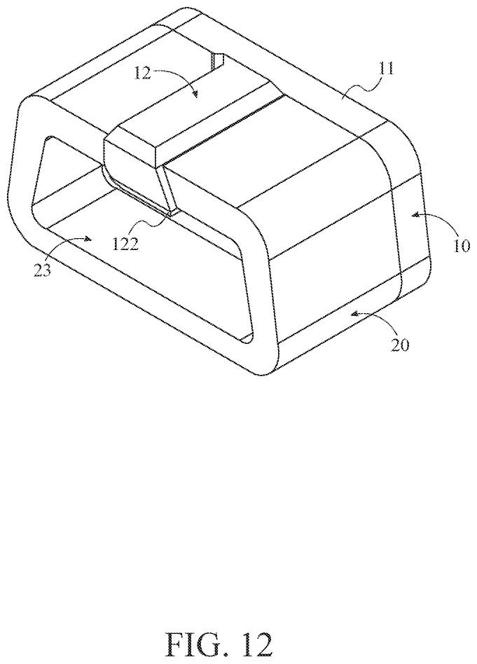

As shown in FIG. 11 and FIG. 12, the present invention further comprises a semi-locked position wherein the arm member 10 is engaging the base member 20. In the semi-locked and locked position, the front facing surface 21 of the base member 20 is adjacent to the rear face 113 of the faceplate 11 of the arm member 10, wherein the at least one through hole 111 of the arm member 10 is aligned with the at least one threaded hole 24 of the base member 20. In such configurations, the angled surface 121 of the arm member 10 engages with the angled wall 221 of the base member 20, preventing a vertical force from disengaging the arm member 10 from the base member 20.

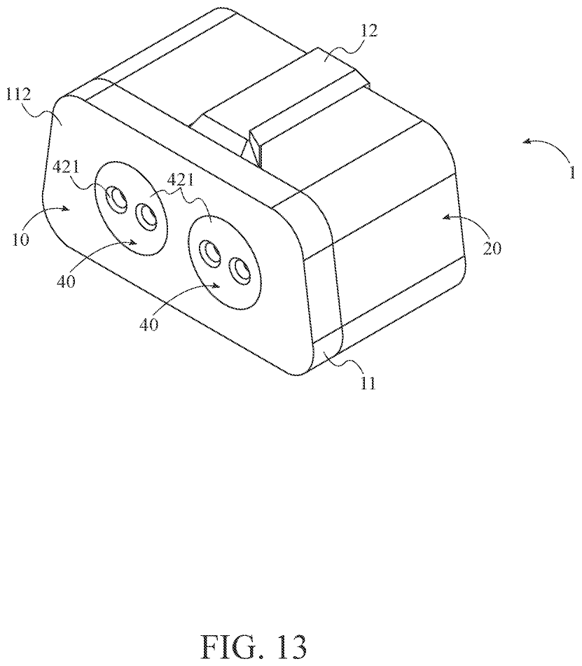

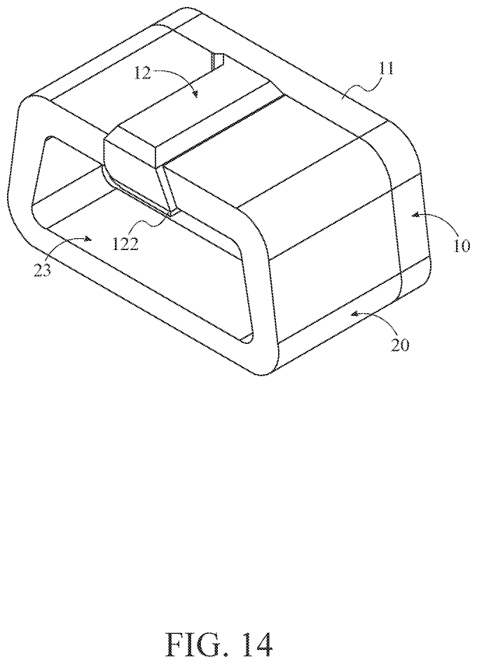

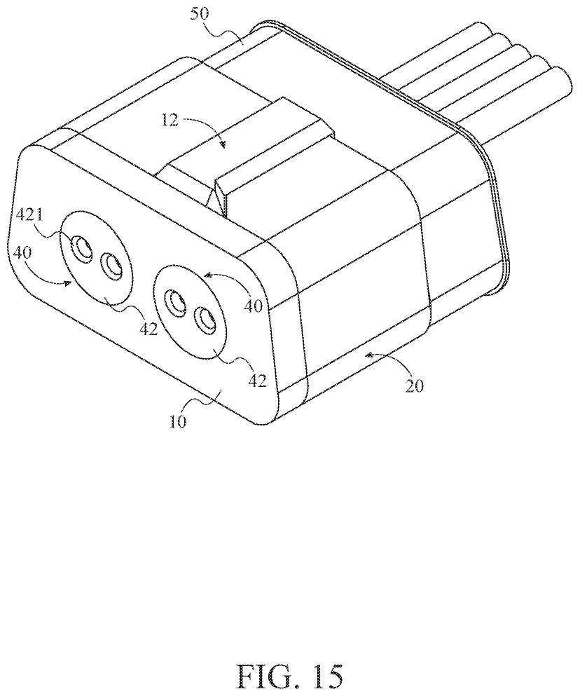

As shown in FIG. 13 and FIG. 14, in the locked configuration, the fasteners 40 are threaded into the base member 20, through the arm member 10, thus securing the arm member 10 to the base member 20. As shown in FIG. 13, in the preferred embodiment of the present invention, the head 42 of the fastener 40 is flush with the front face 112 of the faceplate 11 of the arm member 10. Moreover, as shown in FIG. 14, the fasteners 40, within the preferred embodiment of the present invention, comprise a length that would permit them to thread into the base member 20, without protruding into the receiver cavity 23. As shown in FIG. 15, when in the locked position and coupled to the OBD port 50, the present invention fully enclosed the port 50, preventing an unauthorized user from accessing the OBD port 50.

In the preferred embodiment, the present invention is composed of a PLA plastic material comprising carbon fiber. Additionally, in such embodiments, the present invention is manufactured using a 3D printing technique and manufacturing means known to those in the art.

Although the invention has been explained in relation to its preferred embodiment, it is to be understood that many other possible modifications and variations can be made without departing from the spirit and scope of the invention.

1. An on-board diagnostics port lock comprising:
an arm member comprising a protrusion; and
a base member comprising a channel;
the base member coupling to an on-board diagnostic port wherein the on-board diagnostic port is covered; and
the arm member securing to the base member wherein the protrusion of the arm member fits within the channel of the base member.

2. The on-board diagnostic port lock as claimed in claim 1 wherein the arm member further comprises a face plate;
the protrusion extending normally from the face plate;
the face plate comprising a flat surface that engages with the base member; and
the protrusion traversing a portion of the base member, while in the locked position.

3. The on-board diagnostics port lock as claimed in claim 1 wherein the base member comprises a receiver cavity wherein the on-board diagnostics port is coupled.

4. (canceled)

5. The on-board diagnostic port lock as claimed in claim 2 wherein:
the face plate of the arm member comprises a front face and a rear face;
the base member further comprises a front facing surface;
the front facing surface of the base member being an outwardly facing flat surface, opposite from the receiver cavity;
the front face of the arm member being an outwardly facing surface of the arm member;
the rear face of the arm member being the opposite surface from the front face wherein the rear face engages with the front facing surface of the base member, when in the locked position.

6. The on-board diagnostic port lock as claimed in claim 5 further comprising:
an at least one through hole traversing the arm member; and
an at least one threaded hole traversing the base member;
the through hole traversing the arm member coaxially aligning with the threaded hole of the base member, when in the locked position.

7. The on-board diagnostic port lock as claimed in claim 6 further comprising an at least one fastener;
the fastener coupling the arm member to the base member wherein the fastener traverses both the through hole of the arm member and the threaded hole of the base member;
the fastener threadedly engaging the threaded hole of the base member.

8. The on-board diagnostic port lock as claimed in claim 7 wherein the fastener comprises a plurality of threads and a head;
the head composing a first end of the fastener and the plurality of threads traversing a portion of the fastener opposite of the head.

9. The on-board diagnostic port lock as claimed in claim 8 wherein the head of the fastener comprises a screw slot having a snake eye pattern.

10. The on-board diagnostic port lock as claimed in claim 2 wherein:
the protrusion of the arm member comprises a 45° angle; and
the channel comprising an angled wall having a 45° angle corresponding with the protrusion thus preventing vertical disengagement of the protrusion from the channel.

11. The on-board diagnostics port lock as claimed in claim 2 further comprising a ridge wherein said ridge latches on to the on-board diagnostics port.

12. An on-board diagnostics port lock comprising:
an arm member;
a base member; and
an at least one fastener;
the base member coupling to an on-board diagnostic port wherein the on-board diagnostic port is covered;
the arm member securing to the base member; and
the at least one fastener coupling the arm member to the base member wherein the fastener traverses both the arm member and the base member;
the fastener threadedly engaging the base member.

13. The on-board diagnostic port lock as claimed in claim 12 wherein the arm member comprises a face plate and a protrusion;
the protrusion extending normally from the face plate;
the face plate comprising a flat surface that engages with the base member; and
the protrusion traversing a portion of the base member, while in the locked position.

14. The on-board diagnostics port lock as claimed in claim 13 wherein the base member further comprises:
a front facing surface;
a channel;
a receiver cavity; and
an at least one threaded hole;
wherein:
the front facing surface is a forward outwardly facing surface of the base member that interacts with the faceplate of the arm member,
the channel traversing a portion of the base member wherein the protrusion of the arm member fits within the channel of the base member;
the channel comprising an angled wall;
the receiver cavity being a cavity wherein the on-board diagnostics port is inserted; and
the at least one threaded hole threadedly engaging the at least one fastener.

15. The on-board diagnostics port lock as claimed in claim 14 wherein the arm member further comprises:
an at least one through hole;
a front face;
a rear face;
an angled surface; and
a ridge;
wherein:
the faceplate of the arm member comprises the at least one through hole, the front face, and the rear face;
the protrusion of the arm member comprises the angled surface and the ridge;
the front face of the faceplate being the forward facing outwardly surface of the faceplate;
the rear face being the opposite surface of the faceplate from the front face, said rear face engaging with the front facing surface of the base member when in a locked position;
the angled surface engaging with the angled wall of the channel whereby the interaction prevents a vertical force from disengaging the arm member from the base member;
the ridge latching onto the on-board diagnostics port, thus securing the on-board diagnostics port lock to the on-board diagnostics port.

16. The on-board diagnostic port lock as claimed in claim 12 wherein the fastener comprises a plurality of threads and a head;
the head composing a first end of the fastener and the plurality of threads traversing a portion of the fastener opposite of the head.

17. The on-board diagnostic port lock as claimed in claim 16 wherein the head of the fastener comprises a screw slot having a snake eye pattern.

18. An on-board diagnostics port lock comprising:
an arm member;
a base member; and
an at least one fastener comprising a head;
the base member coupling to an on-board diagnostic port wherein the on-board diagnostic port is covered;
the arm member securing to the base member; and
the at least one fastener coupling the arm member to the base member wherein the fastener traverses both the arm member and the base member;
the fastener threadedly engaging the base member;
the head of the fastener being located on a distal end of the fastener; and
the head of the fastener comprises a screw slot having a snake eye pattern.

19. The on-board diagnostic port lock as claimed in claim 18 further comprising:
a faceplate;
a protrusion;
a channel; and
a receiver cavity;
wherein:
the arm member comprises the face plate and the protrusion;
the base member comprises the channel and the receiver cavity;
the protrusion extending normally from the face plate;
the faceplate comprising a rear face that engages with a front facing surface of the base member;
the protrusion engaging with the channel of the base member, the receiver cavity receiving an on-board diagnostic port; and
the protrusion comprising a ridge wherein said ridge latches onto the on-board diagnostics port.

20. The on-board diagnostics port lock as claimed in claim 19, wherein the base member further comprises an at least one threaded hole wherein the fastener threadedly engages, thus securing the arm member to the base member.
